(19) United States
(12) Patent Application Publication
(10) Pub. No.: US 2026/0281052 A1
(43) Pub. Date: Sep. 17, 2026

(54) APPLICATION IDENTIFICATION FOR TRAFFIC FLOW PRIORITIZATION

(71) Applicant: QUALCOMM Incorporated, San Diego, CA (US)

(72) Inventors: Prasad GADDE, HYDERABAD (IN); Rajesh NADAVA, Hyderabad (IN); Manjunatha Subbamma ANANDA, HYDERABAD (IN); Hariharan SUBRAMANIAN, Kukatpally Hyderabad (IN); Santhana PALANISAMY, Hyderabad (IN)

(21) Appl. No.: 19/077,972

(22) Filed: Mar. 12, 2025

(51) Int. Cl. H04L 47/62; H04L 41/16; H04L 47/2483

(52) U.S. Cl. CPC H04L 47/6215; H04L 41/16; H04L 47/2483

(57) ABSTRACT

This disclosure provides methods, components, devices and systems for providing prioritized traffic flows for latency sensitive applications using application identifications. Some aspects more specifically relate to associating all network traffic or traffic flows from a prioritized application using an application identification (APPID) that is associated to every traffic flow from the prioritized application. In some aspects, all of the APPID associated traffic flows as treated as prioritized traffic flows, when at least one traffic flow from the application is a prioritized network flow or includes prioritized network traffic.

### TECHNICAL FIELD

This disclosure relates generally to wireless communication, and more specifically, to providing prioritized traffic flows for latency sensitive applications using application identifications to route traffic flows.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The communication device includes a processing system that includes one or more processors and one or more memories coupled with the one or more processors, the processing system configured to cause the wireless communication device to receive a traffic flow of a plurality of traffic flows for an application, where the traffic flow is associated with a network flow identification (NFID), and where each traffic flow of the plurality of traffic flows is associated with an application identification (APPID) associating the traffic flow to the application, and provide the traffic flow via a prioritized network queue, where at least one traffic flow associated with the APPID is associated with a prioritized status NFID.

In some examples, the techniques described herein relate to the wireless communication device, where the processing system is further configured to cause the wireless communication device to generate the APPID when the traffic flow is a first traffic flow received from the application, and assign the APPID to the traffic flow and each of the plurality of traffic flows subsequently received from the application.

In some examples, the techniques described herein relate to the wireless communication device, where the processing system is further configured to cause the wireless communication device to associate the traffic flow to the application when the traffic flow includes one of a repeated traffic flow, or a subsequent new traffic flow received from the application, and assign the APPID to the traffic flow.

In some examples, the techniques described herein relate to the wireless communication device, where the traffic flow is a new traffic flow received from the application, and where the processing system is further configured to cause the wireless communication device to select a priority level using network transmission information in the traffic flow, extract the NFID for the traffic flow from the network transmission information, associate the priority level with the NFID, where the NFID is a prioritized status NFID when the priority level indicates the traffic flow is prioritized, and where the NFID is a non-prioritized status NFID when the priority level indicates the traffic flow is not prioritized, and store the NFID, the associated priority level, and the APPID as an APPID-NFID association in an APPID database.

In some examples, the techniques described herein relate to the wireless communication device, where the processing system is further configured to cause the wireless communication device to select the priority level using statically assigned network traffic handling parameters in the network transmission information.

In some examples, the techniques described herein relate to the wireless communication device, where the processing system is further configured to cause the wireless communication device to select the priority level using a machine learning (ML) model to identify the traffic flow as a prioritized traffic flow or not prioritized traffic flow.

In some examples, the techniques described herein relate to a wireless communication device, where the traffic flow is a repeated traffic flow, and where the processing system is further configured to cause the wireless communication device to assign, using APPID-NFID associations stored in an APPID database, the traffic flow to the prioritized network queue when the APPID assigned to the traffic flow is also associated with at least one prioritized status NFID.

In some examples, the techniques described herein relate to the wireless communication device, where the processing system is further configured to cause the wireless communication device to receive the traffic flow from an application device via a network connection.

In some examples, the techniques described herein relate to the wireless communication device, where the processing system is further configured to cause the wireless communication device to provide the APPID to the application device, and receive subsequent traffic flow connections, where the APPID is pre-associated with the subsequent traffic flow connections received from the application device.

In some examples, the techniques described herein relate to the wireless communication device, where the processing system is further configured to cause the wireless communication device to receive the traffic flow from a local instance of the application.

Another innovative aspect of the subject matter described in this disclosure can be implemented in a method for wireless communication by a wireless communication device. The method includes receiving a traffic flow of a plurality of traffic flows for an application, where the traffic flow is associated with a network flow identification (NFID), and where each traffic flow of the plurality of traffic flows is associated with an application identification (APPID) associating the traffic flow to the application, and providing the traffic flow via a prioritized network queue, where at least one traffic flow associated with the APPID is associated with a prioritized status NFID.

Another innovative aspect of the subject matter described in this disclosure can be implemented in a wireless communication device or application client device. The application client device includes one or more processors and one or more memories coupled with the one or more processors, the processing system configured to cause the application client device to provide a traffic flow of a plurality of traffic flows for an application to a network device, where the traffic flow is associated with a network flow identification (NFID), receive an application identification (APPID) for the traffic flow from the network device, where the APPID associates the traffic flow to the application, and provide the plurality of traffic flows for the application with the APPID to the network device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of an example wireless communication system for providing prioritized traffic flows for latency sensitive applications.

FIG. 3 shows a pictorial diagram of an example wireless communication system with multiple traffic flows for latency sensitive applications.

FIG. 4 shows a table of example application identification (APPID)-network flow identification (NFID) associations stored in an APPID database.

FIG. 5 shows a flowchart illustrating an example process performable by or at a wireless communication device that supports providing prioritized traffic flows for latency sensitive applications.

FIG. 6 shows a flowchart illustrating an example process performable by or at a wireless communication device that supports providing prioritized traffic flows for latency sensitive applications.

FIG. 7 shows a flowchart illustrating an example process performable by or at a wireless communication device that supports storing APPID-NFID associations in an APPID database.

FIG. 8 shows a flowchart illustrating an example process performable by or at a wireless communication device that supports providing prioritized traffic flows for latency sensitive applications.

FIG. 9 shows a flowchart illustrating an example process performable by or at an application device that supports providing prioritized traffic flows for latency sensitive applications.

FIG. 10 shows a block diagram of an example wireless communication device that supports providing prioritized traffic flows for latency sensitive applications.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, multimedia applications, including gaming applications, videoconferencing applications, augmented reality (AR)/virtual reality (VR) and other similar applications, require network connections with various quality of service (QoS) metrics, including low latency, to provide a seamless user experience. For example, latency sensitive or prioritized applications may include visual and audio elements that are synced to each other, may be interacted with and updated by a user, and also may contain elements or remote content that are stored on or accessed at remote servers. In some examples, the prioritized applications use network connections and traffic flows to interact with the remote content stored on remote servers, such as a gaming servers, and also to communicate with remote users, such as game players interacting with a different device or at a different geographic location. As the number and frequency of use of latency sensitive applications grows, wireless communication networks need mechanisms for ensuring QoS metrics for the applications, including prioritization of the associated network traffic flows through the communication networks.

Various aspects relate generally to wireless communication and more particularly to providing prioritized traffic flows for applications. Some aspects more specifically relate to associating all network traffic or traffic flows from a prioritized application using an application identification (APPID) and providing all of the APPID associated traffic flows as prioritized flows. For example, when at least one traffic flow from the application is a prioritized network flow or includes prioritized network traffic, every traffic flow received from the application is prioritized in a network queue using the APPID. In some examples, a wireless communication device may include a wireless access point (AP) that receives multiple traffic flows from an application device executing the application. In some examples, the prioritized application may include a multimedia application which sends and receives various types of network traffic using multiple traffic flows. For example, the prioritized application may include an interactive gaming application running on a wireless communication device or application device, such as a dedicated gaming device, a smart phone device, a tablet device, a computer, an augmented reality (AR) device or other similar device. In some examples, the prioritized application may provide application control data, user interaction data, video/visual data, audio data and other types of data and information via multiple different traffic flows in the network. In some examples, the application device generates and assigns the APPID and prioritizes the traffic flows through the network. In some examples, the AP may receive the traffic flows from the application device, generate and assign the APPID and prioritize the traffic flows through the network.

In some aspects, a subset of traffic flows from the application may include prioritized network transmission information or be selected as a prioritized traffic flow, while other traffic flows from the application may not be marked or selected as a prioritized traffic flow. In some examples, in order to provide adequate performance and priority to the application, the wireless communication device associates, using the APPID, both the traffic flows that are marked as prioritized and the traffic flows that are not marked as prioritized. In some examples, when at least one traffic flow associated with an APPID is marked as a traffic flow, the wireless communication device provides every other APPID associated traffic flow, including those not otherwise marked as prioritized, as a prioritized traffic flow. For example, the wireless communication device may communicate the associated traffic flows via a prioritized network queue.

In some aspects, the traffic flows from the application are each associated with a network flow identification (NFID). In some examples, the NFID may indicate whether a respective traffic flow is a prioritized traffic flow. In some examples, the wireless communication device may extract a priority level and the NFID from network transmission information in each respective traffic flow. For example, the network transmission information may include statically assigned network traffic handling parameters that indicate a priority level for the traffic flow. In some examples, wireless communication device also may use a machine learning (ML) model and the network transmission information to extract or select the priority level for the traffic flow. In some examples, the wireless communication device stores the priority level, NFID and APPID as an APPID-NFID association in an APPID database. In some examples, the wireless communication device uses the APPID and APPID-NFID associations to prioritize a given traffic flow when associated with an application with at least one prioritized traffic flow.

Particular aspects of the subject matter described in this disclosure can be implemented to realize one or more of the following potential advantages. Associating traffic flows using an application identification (APPID) and prioritizing all of the APPID associated traffic flows in a network provides for increased application performance for latency sensitive or prioritized applications. For example, by associating every traffic flow from a prioritized application using the APPID, traffic flows that may not otherwise be marked as a prioritized traffic flow are still given priority in a network. In some examples, associating and prioritizing these non-prioritized traffic flows from the prioritized application provides for better overall application performance by allowing for similar priority or latency across all of the traffic flows.

In some examples, the wireless communication device may extract or identify the priority level for a traffic flow using network transmission information where the extracted priority level may be applied to every other traffic flow associated with a same APPID. In some examples, to provide for identification of any potential prioritized traffic flows, the priority level may be extracted from statically assigned network transmission information or derived using the network transmission information and a ML model. In some examples, extracting the priority level from a given traffic flow from the application, where the priority level indicates the traffic flow should be prioritized in the traffic, allows for each other traffic flow associated with the application, via the APPID, to also be prioritized in the network.

In some aspects, storing the APPID and priority levels for a traffic flow in an APPID database, stored locally on the wireless communication device or in an accessible cloud-based database deployment, enables quick recall and identification of traffic flows and associated prioritization requirements. For example, the wireless communication also may extract network flow identification (NFID) from the traffic flow and store the priority level and NFID along with the associated APPID for the traffic flow to provide for a quick look up and prioritization of any traffic flows, including repeated traffic flows, received from a prioritized application.

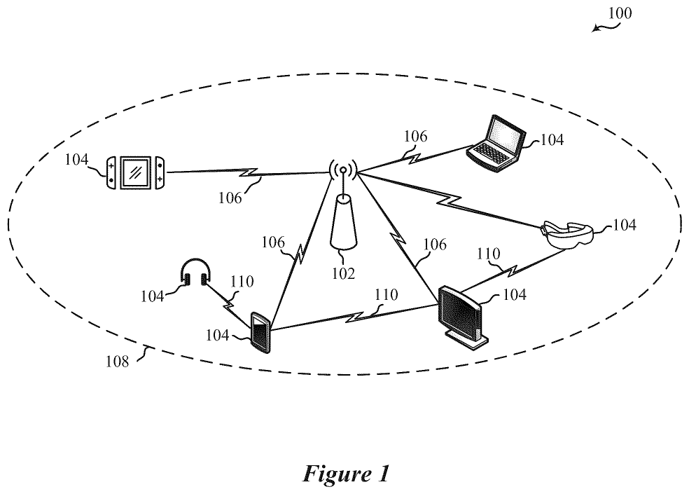

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

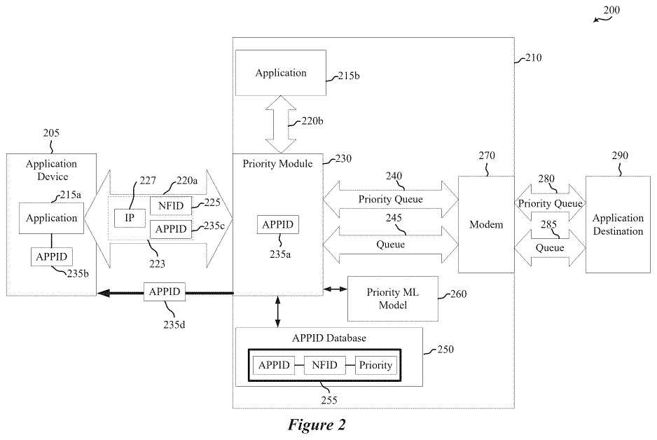

FIG. 2 shows a pictorial diagram of an example wireless communication system 200 for providing prioritized traffic flows for latency sensitive applications. In some examples, the wireless communication system 200 includes a wireless communication device 210 in a network such as the wireless communication network 100 described with reference to FIG. 1. The wireless communication device 210 can be configurable or configured for use in an AP, such as the AP 102 described with reference to FIG. 1. In some examples, the wireless communication device 210 can also be configurable or configured for use in a STA, such as the STA 104 described with reference to FIG. 1. The wireless communication device 210 also may be a server, a distributed device or a cloud-based server where the components of the wireless communication device 210 described herein are distributed as cloud-based modules, services or applications. In some examples, the wireless communication device 210 includes a priority module 230 for associating traffic flows using an application identification (APPID) and prioritizing all of the APPID associated traffic flows in a network to provide for increased application performance for latency sensitive or prioritized applications.

For example, the wireless communication system 200 includes an application 215 (shown as application instance 215a on an application device 205 and local application instance 215b on the wireless communication device 210 in FIG. 2) that provides a traffic flow 220 (shown as traffic flow 220a and traffic flow 220b in FIG. 2) to the priority module 230. In some examples, the application instance 215a provides the traffic flow 220a over a network connection, such as a Wi-Fi connection or other similar connection, to the wireless communication device 210 and the priority module 230. In some examples, the local application instance 215b on the wireless communication device 210 directly provides the traffic flow 220b to the priority module 230.

In some examples, the application 215 is a latency sensitive or prioritized application. For example, the application 215 may be a video game application or similar application/service that relies on fast and reliable network connections in order to provide a seamless user experience or application function. In some examples, the application 215 may include a multimedia application which sends and receives various types of network traffic using multiple traffic flows. For example, the application 215 may include an interactive gaming application running on a wireless communication device or application device, such as a dedicated gaming device, a smart phone device, a tablet device, a computer, an AR/VR device or other similar device. In some examples, a user may interact with a user interface of the application device, where visual or other application components are updated by the user's interactions as well as game actions received from a remote server/location, such as a game server, as well as other user's actions on other devices hosting an application instance (not show in FIG. 2). In these examples, the latency of the various network connections to and from each application instance needs to be minimal to avoid a degraded user experience or other application errors.

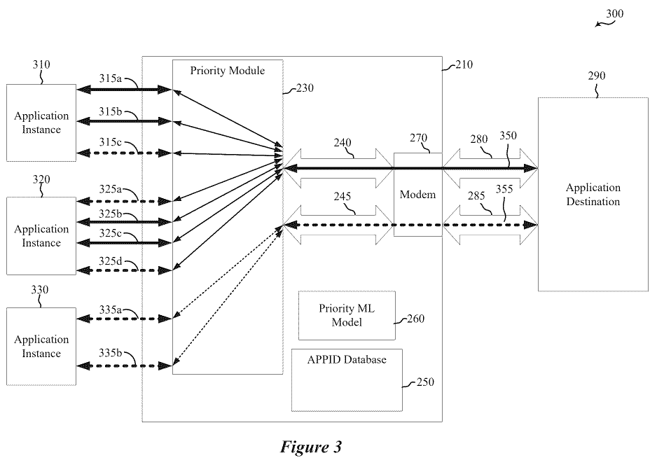

In some examples, latency sensitive or prioritized applications, including the application 215, may create or initiate multiple traffic flows for various types of network traffic. For example, the application 215 may provide application control data, user interaction data, video/visual data, audio data and other types of data and information via multiple different traffic flows in the network. For example, the application 215 may initiate a first traffic flow to carry signaling data and a second traffic flow to carry audio and video data and a third traffic flow to carry other application data. In some examples, the type of traffic flow initiated by the application 215 is based on traffic type for the traffic flow. In some examples, latency sensitive applications also assign or select session and transport layer protocols for the various traffic flows. For example, the application 215 may use Hypertext Transfer Protocol (HTTP)/Internet Control Message Protocol (ICMP) traffic flows for pings/signaling traffic and Transmission Control Protocol (TCP) and User Datagram Protocol (UDP) traffic flows for audio, video, AR and other similar data. Additional examples of multiple traffic flows from an application instance(s) are described herein with reference to FIG. 3.

In some examples, network components, including the wireless communication device 210 meet latency and QoS requirements for latency sensitive applications and traffic flows by prioritizing traffic flows identified as prioritized traffic flows. For example, the priority module 230 maintains traffic queues for traffic flows at the wireless communication device 210 including a priority queue 240 and standard queue 245 to a modem 270. In some examples, the modem 270 provides the traffic flows including the traffic flows in the priority queue 240 and the standard queue 245 to external network destinations, such as an application destination 290. In some examples, the application destination is a server or cloud environment, such as a gaming server/platform, that facilitates the execution of the application 215.

In some examples, the modem 270 provides for traffic flows in the priority queue 240 to be sent and received over an external priority queue 280 and for traffic flows in the standard queue 245 to be sent and received over an external standard queue 285. In some examples, the wireless communication device 210, including the priority module 230 and the modem 270 provision device and network resources such that the traffic flows in the priority queue 240 and external priority queue 280 are given priority over non-priority network traffic and meet QoS requirements, latency requirements, and other similar network requirements for the application 215. For example, the priority queue 240 and the external priority queue 280 may be implemented in system modules including kernel modules, Identity, Policy, and Audit (IPA) systems, Packet Data Convergence Protocol (PDCP) modules, RLC Radio Link Control (RLC) modules among other similar system modules, where the respective module gives or provisions priority to the traffic flows in the priority queues.

In some examples, traffic flows, such as the traffic flows 220a and 220b, are identified and differentiated using various identification means including a network flow identification (NFID) 225. In some examples, the NFID 225 is a tuple such as a 5-Tuple that includes a protocol type, source IP, source Port, destination IP and destination Port. In some examples, the NFID 225, including the 5-Tuple information is used by various system modules to prioritize or de-prioritize traffic flows to reduce latencies, including at the priority module 230, the modem 270 and other network components. For example, the NFID and priority information may be used to route prioritized traffic flows to priority queues implemented in system modules including kernel modules, Identity, Policy, and Audit (IPA) systems, Packet Data Convergence Protocol (PDCP) modules, RLC Radio Link Control (RLC) modules among other similar system modules.

In some examples, the various traffic flows may be identified as prioritized using network layer transmission information statically assigned network traffic handling parameters in the network transmission information in the traffic flow. For example, transmission information 223 may include internet protocol (IP) header information 227 and other information, such as the NFID 225. In some examples, the priority module 230 may select a priority level using the transmission information 223 in the traffic flow 220. For example, for an IP network traffic flow, the priority module 230 may identify the traffic flow as a prioritized traffic flow when an IP header information 227 includes a Type of Service (TOS)/Differentiated Service Code Point (DSCP) which indicates that the traffic flow is prioritized. In some examples, other indications or markers may be used in the transmission information to indicate that the traffic flow is prioritized.

In some examples, the application 215 may not include information in the transmission information that indicates a traffic flow is prioritized. For example, the IP header information 227 or other indicator may not be set to mark the traffic flow as prioritized. In some examples, when the traffic flow is not indicated as prioritized, the respective traffic flow may experience latency in the wireless communication device 210 and the associated communication networks such that the application 215 may experience degraded performance. For example, visual or interactive elements in a gaming application may fail to operate correctly if one of the traffic flows associated with the application is not prioritized between the application instance, such as the application instance 215a and the application destination 290.

In some examples, those traffic flows that are not marked or indicated as prioritized may be identified as associated with the application 215 and prioritized using an ML model, such as a priority ML model 260. In some examples, the priority ML model 260 may use ML based traffic classification methods to label a traffic flow as latency sensitive or otherwise requiring priority. For example, the priority ML model 260 may estimate or predict an expected number of traffic flows from the application 215 based on the application type, previous behavior and other trained factors. However, in some examples, if the expected number of flows is less than an actual number of traffic flows generated/initiated by the application 215, the priority ML model 260 and the priority module 230 may not identify or prioritize all of the traffic flows from the application 215. Additionally, some prioritized applications may communicate with application destinations 290 that are hosted in cloud environments. For example, a gaming server may be hosted in a cloud deployment where the traffic flow is frequently updated based on changing/updating destination information in the cloud deployment. In some examples, the updated traffic flows may not automatically be marked/indicated as priority traffic flows or selected/identified by the priority ML model 260 as a priority flow.

In some examples, to ensure priority for all prioritized applications, including the application 215, the priority module 230 generates and assigns an APPID 235 for the application 215 (shown as APPID instances 235a-235d in FIG. 2). In some examples, the priority module 230 prioritizes the traffic flows through the network using the APPID and an APPID-NFID association database described herein. For example, the priority module 230 generates the APPID instance 235a for the application instance 215a and associates all network traffic or traffic flows from a prioritized application, such as the application instance 215a, using the APPID instance 235a. In some examples, the priority module 230 provides all of the traffic flows associated with the APPID 235 as prioritized flows. For example, when at least one traffic flow from the application instance 215a is a prioritized network flow or includes prioritized network traffic, every traffic flow received from the application is prioritized in a network queue using the APPID. Prioritizing multiple traffic flows is described in more detail herein with reference to FIGS. 3-9.

In some examples, the wireless communication device 210, including the priority module 230, receives the traffic flow 220a from the application instance 215a at the application device 205 over a network connection, such as the communication links 106 described with reference to FIG. 1. In some examples, the traffic flow 220a includes transmission information 223 which includes the NFID 225. In some examples, the traffic flow 220a is one of several traffic flows or a plurality of traffic flows initiated by the application instance 215a (not shown in FIG. 2). In an example where the traffic flow 220a is a first traffic flow received from the application instance 215a, the priority module 230 generates the APPID instance 235a for the first traffic flow and every other traffic flow received from the application instance 215a. For example, the priority module 230 assigns the APPID instance 235a to the traffic flow 220a and each other traffic flow that is subsequently received from the application instance 215a.

In some examples, the traffic flow 220a may be a repeated traffic flow or a subsequent traffic flow. For example, the traffic flow 220a may be reinitiated by the application instances 215a from a previous traffic flow instance. In an example where the traffic flow 220a is a subsequent traffic flow, the traffic flow is received after a previous or first traffic flow has been received from the application instance 215a and the priority module 230. In some examples, the repeated or subsequent flows are associated to the application 215 by reusing the APPID instance 235a and assigning the APPID instance 235a to the repeated/subsequent traffic flow.

In some examples, the priority module 230 may provide the APPID 235 to the application instance. For example, the priority module 230 may provide the APPID instance 235d to the application device 205 and application instance 215a for storage as the APPID instance 235b. In some examples, the application instances 215a uses a local copy of the APPID, APPID instance 235b, to add the APPID instance 235c in the transmission information 223 in the traffic flow 220a and other traffic flows from the application instances 215a. In some examples, the priority module 230 receives subsequent traffic flow connections from the application device 205 and application instance 215a with the APPID instance 235c pre-associated with the subsequent traffic flow connections received from the application device 205. In some examples, the local application instance 215b also may receive the APPID and provide the APPID as part of transmission information in the traffic flow 220b. While described in detail above with reference to the traffic flow 220a, the local application instance 215b and the traffic flow 220b also may include the NFID, transmission information, and the APPID.

In some examples, including when the traffic flow 220a is a first traffic flow or a subsequent traffic flow the priority module 230 may determine or select a priority level using network transmission information in the traffic flow or using the priority ML model 260. For example, the priority module 230 may extract the NFID 225 for the traffic flow from the transmission information 223 and associate the priority level with the NFID 225. In some examples, the NFID is a prioritized status NFID when the priority level indicates the traffic flow is prioritized, and the NFID is a non-prioritized status NFID when the priority level indicates the traffic flow is not prioritized. In some examples, the priority module 230 also stores the NFID 225, the associated priority level, and the APPID instance 235a as an APPID-NFID association 255 in an APPID database 250. In some examples, the APPID database is stored locally on the wireless communication device 210 or in an accessible cloud-based database deployment. In some examples, the APPID and priority levels for a traffic flow in the APPID database 250 enables quick recall and identification of traffic flows and associated prioritization requirements. Additional examples of the APPID database 250 and additional APPID-NFID associations are described herein with reference to FIGS. 3, 4 and 5.

In some examples, the priority module 230 uses the APPID-NFID associations in the APPID database 250 to determine whether a traffic flow, including the traffic flows 220a or 220b should be prioritized via a priority queue. For example, the priority queue 240 provides the traffic flow 220a via a prioritized network queue such as the priority queue 240 and the external priority queue 280, when at least one traffic flow associated with the APPID in APPID-NFID associations stored on the APPID database 250 is associated with a prioritized status NFID. In some examples associating every traffic flow from a prioritized application using the APPID, traffic flows that may not otherwise be marked as a prioritized traffic flows are still given priority in a network as described in more detail with reference to FIGS. 3-8.

FIG. 3 shows a pictorial diagram of an example wireless communication system 300 with multiple traffic flows for latency sensitive applications. In some examples, the wireless communication system 200 includes the wireless communication device 210 described with reference to FIG. 2. In some examples, the wireless communication device 210 includes the priority module 230, the priority ML model 260, APPID database 250 and modem 270. In some examples, the wireless communication device 210, including the priority module 230, associates various traffic flows from an application using an APPID and prioritizes all of the APPID associated traffic flows. In some examples, prioritizing the APPID associated traffic flows in the network provides for increased application performance for latency sensitive or prioritized applications. For example, by associating every traffic flow from a prioritized application using the APPID, traffic flows that may not otherwise be marked as a prioritized traffic flows are still given priority in the network as described in more detail herein.

In some examples, the system 300 includes application instances 310, 320 and 330. In some examples, the application instances 310, 320 and 330 are a same prioritized application executing on different device or are each a different application. In some examples, the application instances may be local instances of the application executing on the wireless communication device 210, similar to the local application instance 215b, described with reference to FIG. 2. In some examples, the application instances also may be executing on device applications, such as the application device 205 described with reference to FIG. 2.

In some examples each of the application instances sends and receives various types of network traffic using multiple traffic flows. For example, the application instance 310 initiates 3 traffic flows, including traffic flows 315a, 315b and 315c. In some examples, the traffic flows 315a and 315b include network transmission information indicating that the traffic flows are prioritized traffic flows or are identified as prioritized traffic flows by the priority ML model 260. In some examples, the traffic flow 315c is not indicated as a prioritized traffic flow by the application instance 310 or is not identified by the priority ML model 260 as a prioritized traffic flow.

In some examples, the application instance 320 initiates 4 traffic flows, including traffic flows 325a, 325b, 325c and 325d. In some examples, the traffic flows 325b and 325c include network transmission information indicating that the traffic flows are prioritized traffic flows or are identified as prioritized traffic flows by the priority ML model 260. In some examples, the traffic flows 325a and 325d are not indicated as a prioritized traffic flow by the application instance 320 or are not identified by the priority ML model 260 as prioritized traffic flows.

In some examples, the application instance 330 initiates 2 traffic flows, including traffic flows 335a and 335b. In some examples, the traffic flows 335a and 335b are not indicated as a prioritized traffic flow by the application instance 330 or are not identified by the priority ML model 260 as prioritized traffic flows. In the example shown in FIG. 3, the application instance 330 does not have any priority traffic flows. For example, the application instance 330 may be in a signaling or other mode before initiating prioritized traffic flows, such that providing prioritized traffic flows is not necessary. In some examples, the application instance 330 may initiate additional traffic flows (not shown in FIG. 3) that are indicated or selected as prioritized.

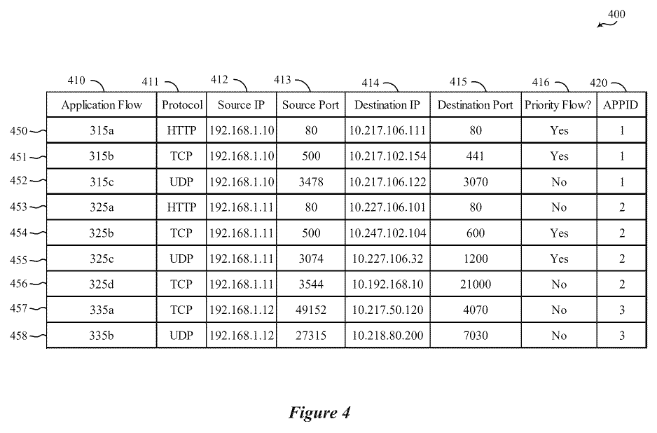

In some examples, to ensure priority is provided for all prioritized traffic flows, the priority module 230 generates and assigns an APPID for each of the application instances 310, 320, and 330. In some examples, the priority module 230 associates all network traffic or traffic flows from each application using the respective APPID. For example, the traffic flows 315a-315c share a common APPID and the traffic flows 325a-325d share a second common APPID. Additional examples of the APPIDs and traffic flows are described with reference to FIG. 4. In some examples, the priority module 230 provides all of the APPID associated traffic flows from an individual application instance as prioritized flows.

In some examples, the wireless communication device 210 may extract or identify the priority level for respective traffic flow using network transmission information or the priority ML model 260 where the extracted or identified priority level may be applied to every other traffic flow associated with a same APPID. For example, when at least one traffic flow from the application instances 310 or 320 is a prioritized network flow or includes prioritized network traffic, every traffic flow received from the application is prioritized in a network queue using the APPID. For example, the traffic flows 315a-315b and 325a-325d are all routed via a prioritized path 350 to the application destination 290 via the priority queue 240 and the external priority queue 280. (While the priority path 305 is shown as a single path to the application destination 290 in FIG. 3, each traffic flow may have a differing destination such that each traffic flow has a different priority path 305). In some examples, associating and prioritizing these non-prioritized traffic flows from the prioritized application provides for better overall application performance for each application instance by allowing for similar priority or latency across all of the traffic flows. In some examples, the traffic flows 335a and 335b are provided over a non-priority or standard path 355 to the application destination via the standard queue 245 and the external standard queue 285. Additional examples of prioritizing traffic flows for prioritized applications and traffic flows are described in more detail in relation to FIGS. 4-9.

FIG. 4 shows a table 400 of example APPID-NFID associations stored in an APPID database. In some examples, the table 400 includes columns 410-420 and rows 450-458 and is stored in an APPID database such as the APPID database 250 described with reference to FIGS. 2 and 3. In some examples, each row in the table 400 is a respective APPID-NFID associations which includes the information shown in the respective column fields in each respective row. In some examples, the column 410 includes a general identification of a traffic flow. For example, referring to the traffic flows described with reference to FIG. 3, column 410 includes an identification of each of the flows 315a-315c, 325a-325d and 335a-335b in respective rows 450-458. In some examples, the columns 411-415 includes an NFID such as N-tuple information for each respective traffic flow. For example, column 411 includes protocol information, column 412 includes a source IP address, column 413 includes source port information, column 414 includes a destination IP address, and column 415 includes a destination port address. In some examples, the N-tuple information for the respective traffic flows is included in transmission information 223 and NFID 225 described with reference to FIG. 2. In some examples, the priority module 230 extracts the NFID for the respective traffic flow from the network transmission information for the traffic flow as described in more detail with reference to FIGS. 2, 5 and 7.

In some examples, the column 416 includes a priority status for each respective traffic flow and column 420 includes the APIDD assigned to the traffic flow by the priority module 230. In some examples, the APPID-NFID association for a respective network flow includes the priority information in the column 416, the APPID in column 420 and the N-tuple information in columns 411-415. In some examples, the NFID for a given traffic flow may include the N-Tuple information in the columns 411-415 and the associated priority status in the column 416 to form prioritized or non-prioritized NFIDs in the APPID database 250. For example, the traffic flow 315c in the row 452 includes NFID in a 5-tuple including that the traffic flow is using UDP, as the communication protocol, in column 411, has a source IP address, a source port, a destination IP address, and a destination port as shown in columns 412-415. The row 452 also includes the priority status of “No” in column 416 and the APPID “1” in column 420.

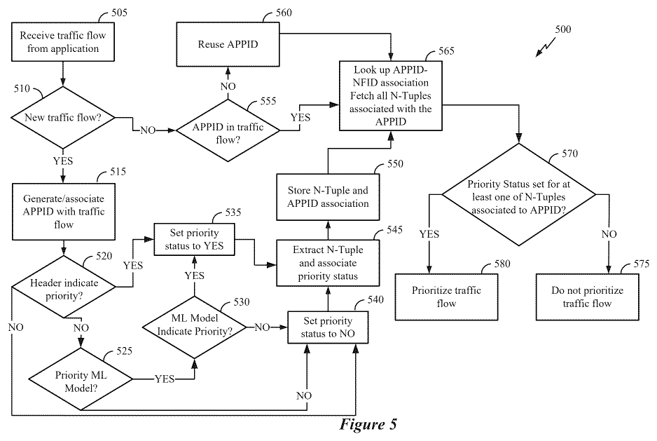

In some examples, using the APPID “1,” the priority module performs a lookup in the table 400 to identify other traffic flows associated with the traffic flow 315c (and the application instance 310). In some examples, by associating the traffic flows 315a, 315b and 315c from the application instance 310, using the APPID “1”, the traffic flow 315c that is not otherwise marked as a prioritized traffic flows is still given priority in the wireless communication device 210 and the network overall. For example, the traffic flows 315a and 315b also have the APPID “1” and are identified or marked as a prioritized status NFID in the column 416. In some examples, the priority module 230 also prioritizes the traffic flow 315c to ensure that the application instance 310 continues to function properly. Associating the traffic flows using the shared APPIDs and prioritizing all of the APPID associated traffic flows provides for increased application performance for the latency sensitive or prioritized applications as described in more detail with reference to FIGS. 5-9.

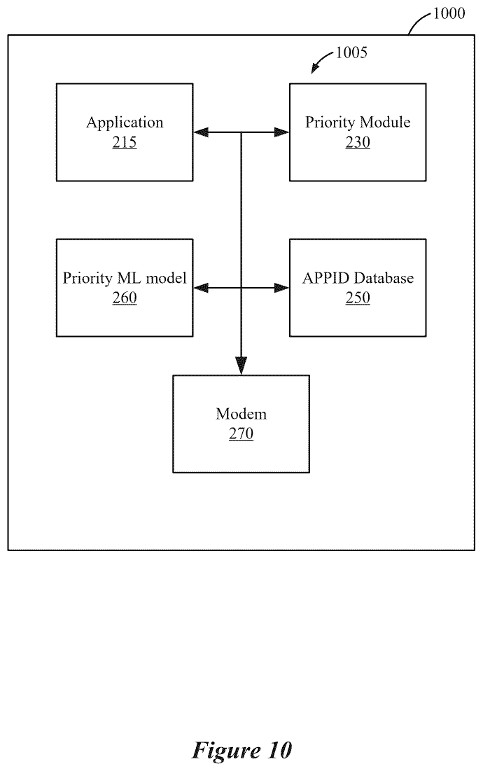

FIG. 5 shows a flowchart illustrating an example process 500 performable by or at a wireless communication device that supports providing prioritized traffic flows for latency sensitive applications. The operations of the process 500 may be implemented by a wireless communication device or its components as described herein. For example, the process 500 may be performed by a wireless communication device, such as the wireless communication device 1000 described with reference to FIG. 10, operating as or within a wireless AP, a wireless STA or other wireless communication device. In some examples, the process 500 may be performed by a wireless AP such as one of the APs 102 or the wireless STA such as one of the STAs 104 described with reference to FIG. 1. In some examples, the process 500 also may be performed by a wireless communication device such as the wireless communication device 210 described with reference to FIGS. 2 and 3.

In some examples, at block 505, the wireless communication device receives a traffic flow from an application. For example, the wireless communication device 210 may receive a traffic flow 220 described with reference to FIG. 2. In some examples the traffic flow is a traffic flow of a plurality of traffic flows for an application such as the traffic flows 315a-315c, 325a-325d or 335a-335b described with reference to FIG. 3. In some examples, each of the traffic flows includes or is associated with transmission information including an NFID such as the NFID 225 in the transmission information 223 described with reference to FIG. 2. In some examples, the wireless communication device 210 receives the traffic flow from an application device via a network connection, such as traffic flow 220a received from the application instance 215a on the application device 205. In some examples, the wireless communication device 210 also may receive the traffic flow from a local instance of the application. For example, the priority module 230 receives the traffic flow 220b from the local application instance 215b. In some examples, the wireless communication device 210, including the priority module 230, associates traffic flows from a given application using an APPID and prioritizes all of the APPID associated traffic flows to provide for increased application performance for latency sensitive or prioritized applications, as described in relation to blocks 510-570.

In some examples, at block 510, the wireless communication device determines whether the traffic flow received at the block 505 is a new traffic flow from the application. In some examples, an application such as the application instance 320 described with reference to FIG. 3 may initiate several traffic flows including traffic flows for various types of network traffic. For example, the application instance 320 may provide individual traffic flows for application control data, user interaction data, video/visual data, audio data and other types of data and information. In some examples, the wireless communication device 210 determines whether the received traffic flow is a new flow or a reinitiated traffic flow from the application. For example, the priority module 230 may determine from the transmission information or other similar indicators whether a given traffic flow is a new traffic flow or a reestablished traffic flow. In some examples, the traffic flow 325a from the application instance 320 is a first traffic flow provided by the application instance 320. In some examples, the traffic flows 325b-325d are subsequent traffic flows as described in more detail below. In some examples, when the traffic flow is a reinitiated or otherwise not a new traffic flow, the process 500 proceeds to block 555. In another example, when the traffic flow is a first traffic flow received from the application, the process 500 proceeds to block 515.

In some examples, at block 515, the wireless communication device generates and associates an APPID with the traffic flow. For example, the wireless communication device 210 generates an APPID 235 when the traffic flow is a first traffic flow received from the application. For example, when the priority module 230 receives the traffic flow 325a, the priority module 230 generates an APPID with a value of “2” as shown in table 400 of FIG. 4. In some examples, the priority module 230 assigns the APPID “2” to the traffic flow 325a and each of the plurality of traffic flows subsequently received from the application, such as the traffic flows 325b-d.

In some examples, at block 520, the wireless communication device determines whether a header in the traffic flow indicates if the traffic flow is a priority traffic flow or non-priority traffic flow. In some examples, various traffic flows may be identified as prioritized using statically assigned network traffic handling parameters in network transmission information. For example, the wireless communication device 210 uses transmission information 223 in the traffic flow such as IP header information 227 or information in the NFID 225 to select a priority level. For example, the priority module 230 may select a priority level using network transmission information in the traffic flow. For example, for an IP traffic flow, the priority module 230 may identify the traffic flow as a prioritized traffic flow when the IP header information 227 includes a TOS/DSCP which indicates that the traffic flow is prioritized. In some examples, other indications or markers may be used in the transmission information to indicate that the traffic flow is prioritized.

In some examples, the application 215 may not include information in the transmission information that indicates a traffic flow is prioritized. For example, the IP header or other indicator may not be set to mark the traffic flow as prioritized. In an example where the IP header information 227 indicates that the traffic flow is a prioritized traffic flow the process 500 proceeds to block 535. In some examples, the IP header does not indicate that the traffic flow is prioritized and the process 500 proceeds to block 525 to check for a priority ML model. In some examples, the IP header does not indicate that the traffic flow is prioritized and the process 500 proceeds directly to block 540, without checking whether a priority ML model is available for the traffic flow.

In some examples, at block 525, the wireless communication device determines whether a priority ML model is available for the traffic flow. For example, the wireless communication device 210 may include the priority ML model 260 and the process 500 proceeds to block 530. In some examples, the priority ML model 260 is not available or the wireless communication device 210 otherwise does not have access to a priority ML model and the process 500 proceeds to block 540.

In some examples, at block 530, the wireless communication device determines whether the priority ML model indicates that the traffic flow is a prioritized traffic flow. In some examples, a traffic flow that is not marked or indicated as prioritized at the block 520, but may be identified as associated with the application instance 320 and prioritized using an ML model, such as a priority ML model 260. In some examples, the priority ML model 260 may use ML based traffic classification methods to label a traffic flow as latency sensitive or otherwise requiring priority. For example, the priority ML model 260 may estimate or predict an expected number of traffic flows from the application instance 320 based on the application type, previous behavior and other trained factors. In an example where the priority ML model 260 does identify the traffic flow as a priority traffic flow, the process 500 proceeds to block 535. In an example where the priority ML model 260 does not identify or indicate that the traffic flow is a priority traffic flow the process 500 proceeds to block 540.

In some examples, at block 535, the wireless communication device sets a priority status to yes for the traffic flow. For example, when the transmission information indicates a priority status at the block 520 or the ML model indicates a priority status at the block 530, the priority module 230 sets a priority status for the flow as “yes.”

In some examples, at block 540, the wireless communication device sets a priority status to no for the traffic flow. For example, when neither the transmission information indicates a priority status at the block 520 nor the ML model indicates a priority status at the block 530, the priority module 230 sets a priority status for the flow as “no.”

In some examples, at block 545, the wireless communication device extracts an N-Tuple and associates the set priority status with the N-Tuple and traffic flow. For example, the priority module 230 may extract 5-Tuple information that includes a protocol type, source IP, source Port, destination IP and destination Port from the NFID 225 in the transmission information 223 and sets a priority status with the N-Tuple information as the NFID. In some examples, the NFID associated with the traffic flow is set as a prioritized status NFID when the priority level indicates the traffic flow is prioritized. In some examples, the NFID associated with the traffic flow is set as a non-prioritized status NFID when the priority level indicates the traffic flow is not prioritized.

In some examples, at block 550, the wireless communication device stores the N-Tuple and APPID as an APPID association. For example, for the traffic flow 325a, the priority module 230 stores the non-prioritized NFID and the APPID “2” as an APPID-NFID association in row 453 of the table 400 in the APPID database 250. For the traffic flow 325b the priority module 230 stores the prioritized NFID and the APPID “2” as an APPID-NFID association in row 454 of the table 400 in the APPID database 250. Upon storing the APPID-NFID association in the APPID database 250, the process 500 proceeds to block 565.

Returning back to block 510 discussed above, when the traffic flow received at block 505 is a reinitiated or otherwise not a new traffic flow, the process 500 proceeds to block 555. In some examples, at block 555, the wireless communication device determines whether an APPID is included in transmission information in the traffic flow. For example, the reinitiated traffic flow may include the APPID previously assigned to the traffic flow, such as the APPID instance 235c, and the process 500 proceeds to block 565. In some examples, the reinitiated traffic flow does not include an APPID and the process 500 proceeds to block 560.

In some examples, at block 560, the wireless communication device reuses the APPID and assigns/associates the APPID to the traffic flow. For example, when a reinitiated traffic flow is received from the application instance 320, the priority module 230 assigns/reuses the APPID “2” to the traffic flow.

In some examples, at block 565, the wireless communication device performs a look up with an APPID-NFID association and fetches all N-Tuples or APPID-NFID associations associated with the APPID. For example, for the traffic flow 325a, the priority module 230 fetches every APPID-NFID association in the table 400 with the APPID “2” to determine whether to prioritize the traffic flow at block 570. In another example, for the traffic flow 325a, the priority module 230 fetches every APPID-NFID association in the table 400 with the APPID “3” to determine whether to prioritize the traffic flow at block 570.

In some examples, at block 570, the wireless communication device determines whether a priority status is set for at least one of N-Tuples associated to APPID. For example, for the APPID “3” the APPID-NFID associations in rows 457 and 458 both indicate a non-prioritized NFID status such that the priority status is not set for at least one traffic flow associated to APPID. In this example, the process 500 proceeds to block 575. In some examples, at block 575, the wireless communication device does not prioritize the traffic flow. For example, for the traffic flows 335a and 335b, the priority module 230 provides the traffic flows via the path 355.

Returning back to block 580, in some examples, the APPID-NFID associations for a traffic flow may indicate a prioritized status. For example, for the APPID “2” the APPID-NFID associations in rows 454 and 455 in the table 400 indicate a prioritized NFID status such that the priority status is set for at least one traffic flow associated to APPID. In an example, where the priority status is set for at least one traffic flow, the process 500 process to the block 580.

In some examples, at block 580, the wireless communication device prioritizes the traffic flow. For example, the priority module 230 assigns the traffic flow 325a to a prioritized network queue, such as the prioritized path 350, including the priority queue 240 and the external priority queue 280, when the APPID assigned to the traffic flow is also associated with at least one prioritized status NFID. In some examples, associating and prioritizing the non-prioritized traffic flows, such as the traffic flow 325a, from the prioritized application, including the application instance 320, provides for better overall application performance by allowing for similar priority or latency across all of the traffic flows 325a-325d.

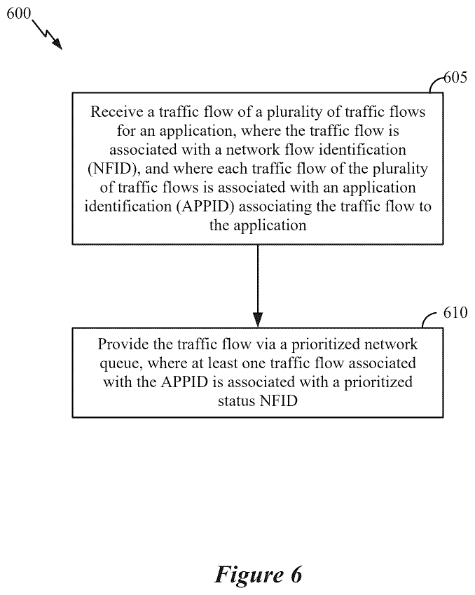

FIG. 6 shows a flowchart illustrating an example process 600 performable by or at a wireless communication device that supports providing prioritized traffic flows for latency sensitive applications. The operations of the process 600 may be implemented by a wireless communication device or its components as described herein. For example, the process 600 may be performed by a wireless communication device, such as the wireless communication device 1000 described with reference to FIG. 10, operating as or within a wireless AP, a wireless STA or other wireless communication device. In some examples, the process 600 may be performed by a wireless AP such as one of the APs 102 or the wireless STA such as one of the STAs 104 described with reference to FIG. 1. In some examples, the process 600 may be performed by a wireless communication device such as the wireless communication device 210 described with reference to FIGS. 2 and 3.

In some examples, at block 605, the wireless communication device receives a traffic flow of a plurality of traffic flows for an application. In some examples, the wireless communication device receives the traffic flow from an application device via a network connection. For example, as described with reference to block 505 of FIG. 5, the wireless communication device receives a traffic flow from an application. For example, the wireless communication device 210 may receive a traffic flow 220 described with reference to FIG. 2. In some examples the traffic flow is a traffic flow of a plurality of traffic flows for an application such as the traffic flows 315a-315c, 325a-325d or 335a-335b described with reference to FIG. 3. In some examples, each of the traffic flows includes or is associated with transmission information including an NFID such as the NFID 225 in the transmission information 223 described with reference to FIG. 2. In some examples, each traffic flow of the plurality of traffic flows is associated with an APPID associating the traffic flow to the application which may be pre-associated or generated and assigned/associated to the traffic flow as described herein. In some examples, the wireless communication device 210 receives the traffic flow from an application device via a network connection, such as traffic flow 220a received from the application instance 215a on the application device 205. In some examples, the wireless communication device 210 also may receive the traffic flow from a local instance of the application. For example, the priority module 230 receives the traffic flow 220b from the local application instance 215b.

In some examples, at block 610, the wireless communication device provides the traffic flow via a prioritized network queue. For example, the wireless communication device provides the traffic flow via a prioritized network queue when at least one traffic flow associated with the APPID is associated with a prioritized status NFID. For example, with reference to block 565 of FIG. 5, the wireless communication device may perform a look up with an APPID-NFID association and fetches all N-Tuples or APPID-NFID associations associated with an APPID for a traffic flow. For example, for the traffic flow 325a in FIG. 3, the priority module 230 fetches every APPID-NFID association in the table 400 with the APPID “2” to determine whether to prioritize the traffic flow at block 570.

With reference to block 570 of FIG. 5, the wireless communication device may determine whether a priority status is set for at least one of N-Tuples associated to APPID. For example, for the APPID “2,” the APPID-NFID associations in rows 454 and 455 in the table 400 indicate a prioritized NFID status such that the priority status is set for at least one traffic flow associated to APPID. In some examples, the priority module 230 prioritizes the traffic flow by assigning the traffic flow 325a to a prioritized network queue, such as the prioritized path 350 described with reference to FIG. 3, including the priority queue 240 and the external priority queue 280, when the APPID assigned to the traffic flow is also associated with at least one prioritized status NFID. In some examples, associating and prioritizing the non-prioritized traffic flows, such as the traffic flow 325a, from the prioritized application, including the application instance 320, provides for better overall application performance by allowing for similar priority or latency across all of the traffic flows 325a-325d.

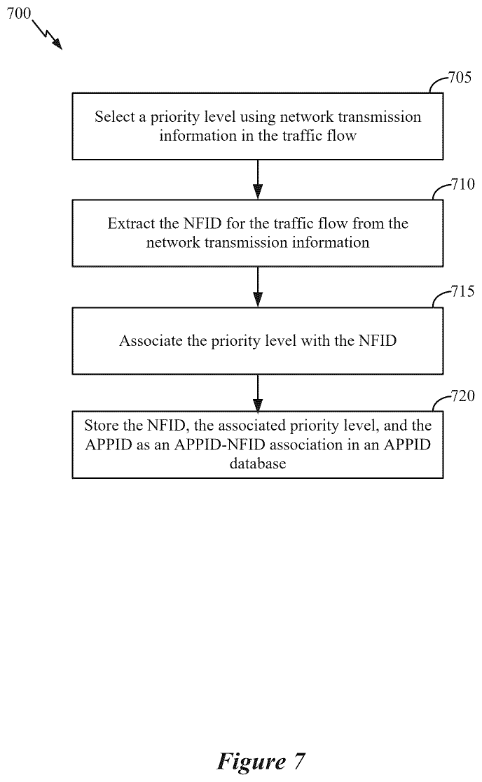

FIG. 7 shows a flowchart illustrating an example process 700 performable by or at a wireless communication device that supports storing APPID-NFID associations in an APPID database. The operations of the process 700 may be implemented by a wireless communication device or its components as described herein. For example, the process 700 may be performed by a wireless communication device, such as the wireless communication device 1000 described with reference to FIG. 10, operating as or within a wireless AP, a wireless STA or other wireless communication device. In some examples, the process 700 may be performed by a wireless AP such as one of the APs 102 or the wireless STA such as one of the STAs 104 described with reference to FIG. 1. In some examples, the process 700 may be performed by a wireless communication device such as the wireless communication device 210 described with reference to FIGS. 2 and 3.

In some examples, at block 705, the wireless communication device selects a priority level using network transmission information in the traffic flow. In some examples, to provide for identification of any potential prioritized traffic flows, the priority level may be extracted from statically assigned network transmission information or derived using the network transmission information and a ML model. In some examples, extracting the priority level from a given traffic flow from the application, where the priority level indicates the traffic flow should be prioritized in the traffic, allows for each other traffic flow associated with the application, via the APPID, to also be prioritized in the network.

For example, with reference to block 520 of FIG. 5, the wireless communication device determines whether a header in the traffic flow indicates if the traffic flow is a priority traffic flow or non-priority traffic flow. In some examples, various traffic flows may be identified as prioritized using statically assigned network traffic handling parameters in network transmission information. For example, the wireless communication device 210 uses transmission information 223 in the traffic flow such as IP header information 227 or information in the NFID 225 to select a priority level. For example, the priority module 230 may select a priority level using network transmission information in the traffic flow. For example, for an IP traffic flow, the priority module 230 may identify the traffic flow as a prioritized traffic flow when the IP header information 227 includes a TOS/DSCP which indicates that the traffic flow is prioritized. In some examples, other indications or markers may be used in the transmission information to indicate that the traffic flow is prioritized.

In some examples, the wireless communication device selects the priority level using a machine learning (ML) model to identify the traffic flow as a prioritized traffic flow or not prioritized traffic flow. For example, with reference to block 530 of FIG. 5, the wireless communication device may determine whether a priority ML model indicates that the traffic flow is a prioritized traffic flow. In some examples, a traffic flow that is not marked or indicated as prioritized may be identified as associated with a prioritized application and prioritized or given a priority level using an ML model, such as the priority ML model 260. In some examples, the priority ML model 260 may use ML based traffic classification methods to label a traffic flow as latency sensitive or otherwise requiring priority. For example, the priority ML model 260 may estimate or predict an expected number of traffic flows from the application instance 320 based on the application type, previous behavior and other trained factors.

In some examples, at block 710, the wireless communication device extracts the NFID for the traffic flow from the network transmission information and associates the priority level with the NFID at block 715. For example, the wireless communication device may extract an N-Tuple and associate the set priority level determined at the block 710 with the N-Tuple and traffic flow at the block 715. For example, the priority module 230 may extract 5-Tuple information that includes a protocol type, source IP, source Port, destination IP and destination Port from the NFID 225 in the transmission information 223 and sets a priority status with the N-Tuple information as the NFID. In some examples, the NFID associated with the traffic flow is set as a prioritized status NFID when the priority level indicates the traffic flow is prioritized. In some examples, the NFID associated with the traffic flow is set as a non-prioritized status NFID when the priority level indicates the traffic flow is not prioritized.

In some examples, at block 720, the wireless communication device stores the NFID, the associated priority level, and the APPID as an APPID-NFID association in an APPID database. For example, the wireless communication device 210 may store the extracted N-Tuple and APPID as an APPID association. For example, for the traffic flow 325a, the priority module 230 stores the non-prioritized NFID and the APPID “2” as an APPID-NFID association in row 453 of the table 400 in the APPID database 250. For the traffic flow 325b the priority module 230 stores the prioritized NFID and the APPID “2” as an APPID-NFID association in row 454 of the table 400 in the APPID database 250. In some examples, extracting the NFID from the traffic flow and storing the priority level and NFID along with the associated APPID for the traffic flow provides for a quick look up and prioritization of any traffic flows, including repeated traffic flows, received from a prioritized application as described with reference to process 500 of FIG. 5 and process 600 of FIG. 6.

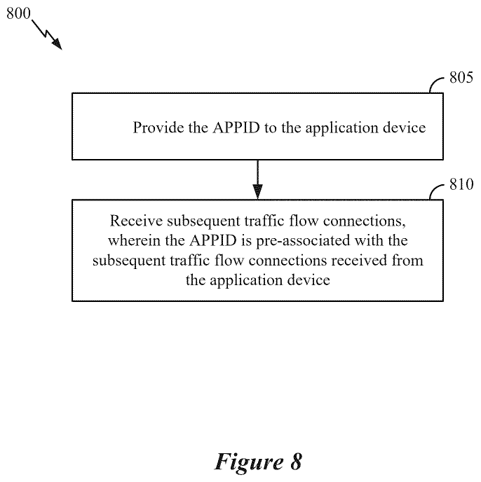

FIG. 8 shows a flowchart illustrating an example process 800 performable by or at a wireless communication device that supports providing prioritized traffic flows for latency sensitive applications. The operations of the process 800 may be implemented by a wireless communication device or its components as described herein. For example, the process 800 may be performed by a wireless communication device, such as the wireless communication device 1000 described with reference to FIG. 10, operating as or within a wireless AP, a wireless STA or other wireless communication device. In some examples, the process 800 may be performed by a wireless AP such as one of the APs 102 or the wireless STA such as one of the STAs 104 described with reference to FIG. 1. In some examples, the process 800 may be performed by a wireless communication device such as the wireless communication device 210 described with reference to FIGS. 2 and 3.

In some examples, at block 805, the wireless communication device provides the APPID to an application device. For example, with reference to FIG. 2, the priority module 230 may provide the APPID 235 to an application instance. For example, the priority module 230 may provide the APPID instance 235d to the application device 205 and application instance 215a for storage as the APPID instance 235b.

In some examples, at block 810, the wireless communication device receives subsequent traffic flow connections. In some examples, the APPID is pre-associated with the subsequent traffic flow connections received from the application device. For example, the application instances 215a uses a local copy of the APPID, APPID instance 235b, to add the APPID instance 235c in the transmission information 223 in the traffic flow 220a and other traffic flows from the application instances 215a. In some examples, the priority module 230 receives subsequent traffic flow connections from the application device 205 and application instance 215a with the APPID instance 235c pre-associated with the subsequent traffic flow connections received from the application device 205. In some examples, the pre-associated APPID simplifies the APPID assignment and lookup processes described above in relation FIGS. 5 and 6.

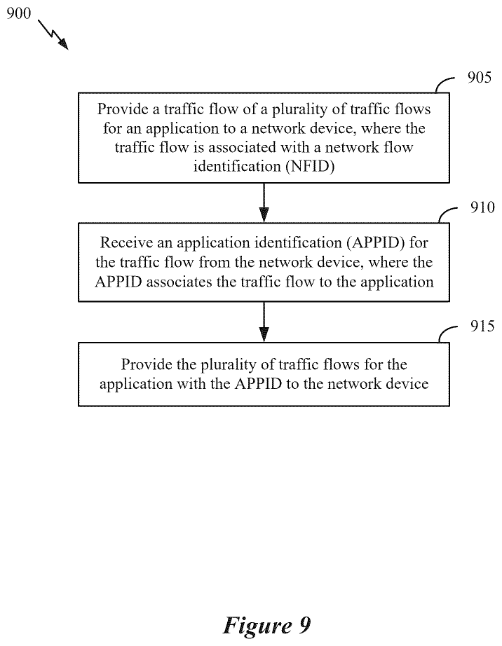

FIG. 9 shows a flowchart illustrating an example process 900 performable by or at an application device that supports providing prioritized traffic flows for latency sensitive applications. The operations of the process 900 may be implemented by a wireless communication device or its components as described herein. For example, the process 900 may be performed by a wireless communication device, such as the wireless communication device 1000 described with reference to FIG. 10, operating as or within a wireless AP, a wireless STA or other wireless communication device. In some examples, the process 900 may be performed by a wireless AP such as one of the APs 102 or the wireless STA such as one of the STAs 104 described with reference to FIG. 1. In some examples, the process 900 may be performed by a wireless communication device such as the wireless communication device 210 or the application device 205 both described with reference to FIGS. 2 and 3.

In some examples, at block 905, the application device provides a traffic flow of a plurality of traffic flows for an application to a network device. For example, with reference to FIG. 2, the application device 205 provides the traffic flow 220a from the application instance 215a over a network connection to the wireless communication device 210. In some examples, the traffic flow is associated with NFID. For example, the traffic flow 220a includes transmission information 223 which includes the NFID 225. In some examples, the traffic flow may be one of several traffic flows or a plurality of traffic flows initiated by an application instance such as the flows 315a-315c described with reference to FIG. 3.

In some examples, at block 910, the application device receives an application APPID for the traffic flow from the network device. For example, with reference to FIG. 2, the priority module 230 may provide the APPID 235 to an application instance, including providing the APPID instance 235d to the application device 205 and application instance 215a for storage as the APPID instance 235b. In some examples, the APPID associates the traffic flow provided by the application device at block 905 to the application executing on the application device.

In some examples, at block 915, the application device provides the plurality of traffic flows for the application with the APPID to the network device. For example, the application device may provide the APPID as a pre-associated APPID in every traffic flow provided from the application instances 215a. For example, the application instances 215a uses a local copy of the APPID, APPID instance 235b, to add the pre-associated APPID instance 235c in the transmission information 223 in the traffic flow 220a and other traffic flows initiated from the application instances 215a. In some examples, the application device 205 provides the traffic flow and subsequent traffic flows with the APPID instance 235c to the wireless communication device 210. In some examples, the pre-associated APPID provided by the application device simplifies the APPID assignment and lookup processes performed at the wireless communication device 210 and described above in relation FIGS. 5 and 6.

FIG. 10 shows a block diagram of an example wireless communication device 1000 that supports providing prioritized traffic flows for latency sensitive applications. In some examples, the wireless communication device 1000 is configured to perform the processes 500, 600, 700, 800 and 900 described, respectively, with reference to FIGS. 5-9. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP or STA, such as the AP 102 and STA 104, described with reference to FIG. 1. In some examples, the wireless communication device 210 can also be configurable or configured for use in an application device or other network device, such as the application device 205 and the wireless communication device 210 described with reference to FIG. 2. In some other examples, the wireless communication device 1000 can be an AP, STA or other network device that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes various components 1005. The components 1005 may include an application 215, a priority module 230, a priority ML model 260, an APPID database 250, and a modem 270. Portions of one or more of the 1005 components may be implemented at least in part in hardware or firmware. For example, the priority module 230 may be implemented at least in part by a processor or a modem. In some examples, portions of one or more of the components 1005 may be implemented at least in part by a processor and software in the form of processor-executable code stored in a memory.

The priority module 230 is configurable or configured to receive a traffic flow of a plurality of traffic flows for an application, where the traffic flow is associated with a network flow identification (NFID), and where each traffic flow of the plurality of traffic flows is associated with an application identification (APPID) associating the traffic flow to the application. The priority module 230 is configurable or configured to provide the traffic flow via a prioritized network queue, where at least one traffic flow associated with the APPID is associated with a prioritized status NFID.

Implementation examples are described in the following numbered clauses:

Clause 1. A wireless communication device, including: a processing system that includes one or more processors and one or more memories coupled with the one or more processors, the processing system configured to cause the wireless communication device to: receive a traffic flow of a plurality of traffic flows for an application, where the traffic flow is associated with a network flow identification (NFID), and where each traffic flow of the plurality of traffic flows is associated with an application identification (APPID) associating the traffic flow to the application; and provide the traffic flow via a prioritized network queue, where at least one traffic flow associated with the APPID is associated with a prioritized status NFID.

Clause 2. The wireless communication device of clause 1, where the processing system is further configured to cause the wireless communication device to: generate the APPID when the traffic flow is a first traffic flow received from the application; and assign the APPID to the traffic flow and each of the plurality of traffic flows subsequently received from the application.

Clause 3. The wireless communication device of any of clauses 1-2, where the processing system is further configured to cause the wireless communication device to: associate the traffic flow to the application when the traffic flow includes one of: a repeated traffic flow, or a subsequent new traffic flow received from the application; and assign the APPID to the traffic flow.

Clause 4. The wireless communication device of any of clauses 1-3, where the traffic flow is a new traffic flow received from the application, and where the processing system is further configured to cause the wireless communication device to: select a priority level using network transmission information in the traffic flow; extract the NFID for the traffic flow from the network transmission information; associate the priority level with the NFID, where the NFID is a prioritized status NFID when the priority level indicates the traffic flow is prioritized, and where the NFID is a non-prioritized status NFID when the priority level indicates the traffic flow is not prioritized; and store the NFID, the associated priority level, and the APPID as an APPID-NFID association in an APPID database.

Clause 5. The wireless communication device of any of clauses 1-4, where the processing system is further configured to cause the wireless communication device to: select the priority level using statically assigned network traffic handling parameters in the network transmission information.

Clause 6. The wireless communication device of any of clauses 1-5, where the processing system is further configured to cause the wireless communication device to: select the priority level using a machine learning (ML) model to identify the traffic flow as a prioritized traffic flow or not prioritized traffic flow.

Clause 7. The wireless communication device of any of clauses 1-6, where the traffic flow is a repeated traffic flow, and where the processing system is further configured to cause the wireless communication device to: assign, using APPID-NFID associations stored in an APPID database, the traffic flow to the prioritized network queue when the APPID assigned to the traffic flow is also associated with at least one prioritized status NFID.

Clause 8. The wireless communication device of any of clauses 1-7, where the processing system is further configured to cause the wireless communication device to: receive the traffic flow from an application device via a network connection.

Clause 9. The wireless communication device of any of clauses 1-8, where the processing system is further configured to cause the wireless communication device to: provide the APPID to the application device; and receive subsequent traffic flow connections, where the APPID is pre-associated with the subsequent traffic flow connections received from the application device.

Clause 10. The wireless communication device of any of clauses 1-9, where the processing system is further configured to cause the wireless communication device to: receive the traffic flow from a local instance of the application.

Clause 11. A method for wireless communication by a wireless communication device, including: receiving a traffic flow of a plurality of traffic flows for an application, where the traffic flow is associated with a network flow identification (NFID), and where each traffic flow of the plurality of traffic flows is associated with an application identification (APPID) associating the traffic flow to the application; and providing the traffic flow via a prioritized network queue, where at least one traffic flow associated with the APPID is associated with a prioritized status NFID.

Clause 12. The method of clause 11, where receiving the traffic flow further includes: generating the APPID when the traffic flow is a first traffic flow received from the application; and assigning the APPID to the traffic flow and each of the plurality of traffic flows subsequently received from the application.

Clause 13. The method of any of clauses 11-12, where receiving the traffic flow further includes: associating the traffic flow to the application when the traffic flow includes one of: a repeated traffic flow, or a subsequent new traffic flow received from the application; and assigning the APPID to the traffic flow.

Clause 14. The method of any of clauses 11-13, where the traffic flow is a new traffic flow received from the application, and where the method further includes: selecting a priority level using network transmission information in the traffic flow; extracting the NFID for the traffic flow from the network transmission information; associating the priority level with the NFID, where the NFID is a prioritized status NFID when the priority level indicates the traffic flow is prioritized, and where the NFID is a non-prioritized status NFID when the priority level indicates the traffic flow is not prioritized; and storing the NFID, the associated priority level, and the APPID as an APPID-NFID association in an APPID database.

Clause 15. The method of any of clauses 11-14, where selecting the priority level from the network transmission information further includes one or more of: selecting the priority level using statically assigned network traffic handling parameters in the network transmission information; and selecting the priority level using a machine learning (ML) model to identify the traffic flow as a prioritized traffic flow or not prioritized traffic flow.

Clause 16. The method of any of clauses 11-15, where the traffic flow is a repeated traffic flow, and where the method further includes: assigning, using APPID-NFID associations stored in an APPID database, the traffic flow to the prioritized network queue when the APPID assigned to the traffic flow is also associated with at least one prioritized status NFID.

Clause 17. The method of any of clauses 11-16, where receiving the traffic flow further includes: receiving the traffic flow from an application device via a network connection.

Clause 18. The method of any of clauses 11-17, further including: providing the APPID to the application device; and receiving subsequent traffic flow connections, where the APPID is pre-associated with the subsequent traffic flow connections received from the application device.

Clause 19. The method of any of clauses 11-18, where receiving the traffic flow further includes: receiving the traffic flow from a local instance of the application.

Clause 20. A non-transitory processor-readable storage medium including processor-readable instructions configured to cause one or more processors to perform a process at a wireless communication device, including code for: receiving a traffic flow of a plurality of traffic flows for an application, where the traffic flow is associated with a network flow identification (NFID), and where each traffic flow of the plurality of traffic flows is associated with an application identification (APPID) associating the traffic flow to the application; and providing the traffic flow via a prioritized network queue, where at least one traffic flow associated with the APPID is associated with a prioritized status NFID.

Clause 21. The non-transitory processor-readable storage medium of clause 20, where receiving the traffic flow further includes: generating the APPID when the traffic flow is a first traffic flow received from the application; and assigning the APPID to the traffic flow and each of the plurality of traffic flows subsequently received from the application.

Clause 22. The non-transitory processor-readable storage medium of any of clauses 20-21, where receiving the traffic flow further includes: associating the traffic flow to the application when the traffic flow includes one of: a repeated traffic flow, or a subsequent new traffic flow received from the application; and assigning the APPID to the traffic flow.

Clause 23. The non-transitory processor-readable storage medium of any of clauses 20-22, where the traffic flow is a new traffic flow received from the application, and further including code for: selecting a priority level using network transmission information in the traffic flow; extracting the NFID for the traffic flow from the network transmission information; associating the priority level with the NFID, where the NFID is a prioritized status NFID when the priority level indicates the traffic flow is prioritized, and where the NFID is a non-prioritized status NFID when the priority level indicates the traffic flow is not prioritized; and storing the NFID, the associated priority level, and the APPID as an APPID-NFID association in an APPID database.

Clause 24. The non-transitory processor-readable storage medium of any of clauses 20-23, where selecting the priority level from the network transmission information further includes one or more of: selecting the priority level using statically assigned network traffic handling parameters in the network transmission information; and selecting the priority level using a machine learning (ML) model to identify the traffic flow as a prioritized traffic flow or not prioritized traffic flow.

Clause 25. The non-transitory processor-readable storage medium of any of clauses 20-24, where the traffic flow is a repeated traffic flow, and further including code for: assigning, using APPID-NFID associations stored in an APPID database, the traffic flow to the prioritized network queue when the APPID assigned to the traffic flow is also associated with at least one prioritized status NFID.

Clause 26. The non-transitory processor-readable storage medium of any of clauses 20-25, where receiving the traffic flow further includes: receiving the traffic flow from an application device via a network connection.

Clause 27. The non-transitory processor-readable storage medium of any of clauses 20-26, further including: providing the APPID to the application device; and receiving subsequent traffic flow connections, where the APPID is pre-associated with the subsequent traffic flow connections received from the application device.

Clause 28. The non-transitory processor-readable storage medium of any of clauses 20-27, where receiving the traffic flow further includes: receiving the traffic flow from a local instance of the application.

Clause 29. An apparatus for wireless communication by a wireless communication device, including: means for: receiving a traffic flow of a plurality of traffic flows for an application, where the traffic flow is associated with a network flow identification (NFID), and where each traffic flow of the plurality of traffic flows is associated with an application identification (APPID) associating the traffic flow to the application; and providing the traffic flow via a prioritized network queue, where at least one traffic flow associated with the APPID is associated with a prioritized status NFID.

Clause 30. The apparatus of clause 29, where receiving the traffic flow further includes: generating the APPID when the traffic flow is a first traffic flow received from the application; and assigning the APPID to the traffic flow and each of the plurality of traffic flows subsequently received from the application.

Clause 31. The apparatus of any of clauses 29-30, where receiving the traffic flow further includes: associating the traffic flow to the application when the traffic flow includes one of: a repeated traffic flow, or a subsequent new traffic flow received from the application; and assigning the APPID to the traffic flow.

Clause 32. The apparatus of any of clauses 29-31, where the traffic flow is a new traffic flow received from the application, and where the apparatus further includes means for: selecting a priority level using network transmission information in the traffic flow; extracting the NFID for the traffic flow from the network transmission information; associating the priority level with the NFID, where the NFID is a prioritized status NFID when the priority level indicates the traffic flow is prioritized, and where the NFID is a non-prioritized status NFID when the priority level indicates the traffic flow is not prioritized; and storing the NFID, the associated priority level, and the APPID as an APPID-NFID association in an APPID database.

Clause 33. The apparatus of any of clauses 29-32, where selecting the priority level from the network transmission information further includes one or more of: selecting the priority level using statically assigned network traffic handling parameters in the network transmission information; and selecting the priority level using a machine learning (ML) model to identify the traffic flow as a prioritized traffic flow or not prioritized traffic flow.

Clause 34. The apparatus of any of clauses 29-33, where the traffic flow is a repeated traffic flow, and where the apparatus further includes means for: assigning, using APPID-NFID associations stored in an APPID database, the traffic flow to the prioritized network queue when the APPID assigned to the traffic flow is also associated with at least one prioritized status NFID.

Clause 35. The apparatus of any of clauses 29-34, where receiving the traffic flow further includes: receiving the traffic flow from an application device via a network connection.

Clause 36. The apparatus of any of clauses 29-35, further including: providing the APPID to the application device; and receiving subsequent traffic flow connections, where the APPID is pre-associated with the subsequent traffic flow connections received from the application device.

Clause 37. The apparatus of any of clauses 29-36, where receiving the traffic flow further includes: receiving the traffic flow from a local instance of the application.

Clause 38. An application client device, including: a processing system that includes one or more processors and one or more memories coupled with the one or more processors, the processing system configured to cause the application client device to: provide a traffic flow of a plurality of traffic flows for an application to a network device, where the traffic flow is associated with a network flow identification (NFID), receive an application identification (APPID) for the traffic flow from the network device, where the APPID associates the traffic flow to the application; and provide the plurality of traffic flows for the application with the APPID to the network device.

Clause 39. A method for wireless communication by an application client device, the method including: providing a traffic flow of a plurality of traffic flows for an application to a network device, where the traffic flow is associated with a network flow identification (NFID), receiving an application identification (APPID) for the traffic flow from the network device, where the APPID associates the traffic flow to the application; and providing the plurality of traffic flows for the application with the APPID to the network device.

Clause 40. A non-transitory processor-readable storage medium including processor-readable instructions configured to cause one or more processors to perform a process at a wireless communication device, including code for: providing a traffic flow of a plurality of traffic flows for an application to a network device, where the traffic flow is associated with a network flow identification (NFID), receiving an application identification (APPID) for the traffic flow from the network device, where the APPID associates the traffic flow to the application; and providing the plurality of traffic flows for the application with the APPID to the network device.

Clause 41. An apparatus for wireless communication by an application client device, including means for: providing a traffic flow of a plurality of traffic flows for an application to a network device, where the traffic flow is associated with a network flow identification (NFID), receiving an application identification (APPID) for the traffic flow from the network device, where the APPID associates the traffic flow to the application; and providing the plurality of traffic flows for the application with the APPID to the network device.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes one or more processors and one or more memories coupled with the one or more processors, the processing system configured to cause the wireless communication device to:
receive a traffic flow of a plurality of traffic flows for an application,
wherein the traffic flow is associated with a network flow identification (NFID), and
wherein each traffic flow of the plurality of traffic flows is associated with an application identification (APPID) associating the traffic flow to the application; and
provide the traffic flow via a prioritized network queue, wherein at least one traffic flow associated with the APPID is associated with a prioritized status NFID.

2. The wireless communication device of claim 1, wherein the processing system is further configured to cause the wireless communication device to:
generate the APPID when the traffic flow is a first traffic flow received from the application; and
assign the APPID to the traffic flow and each of the plurality of traffic flows subsequently received from the application.

3. The wireless communication device of claim 1, wherein the processing system is further configured to cause the wireless communication device to:
associate the traffic flow to the application when the traffic flow comprises one of:
a repeated traffic flow, or
a subsequent new traffic flow received from the application; and
assign the APPID to the traffic flow.

4. The wireless communication device of claim 1, wherein the traffic flow is a new traffic flow received from the application, and wherein the processing system is further configured to cause the wireless communication device to:
select a priority level using network transmission information in the traffic flow;
extract the NFID for the traffic flow from the network transmission information;
associate the priority level with the NFID,
wherein the NFID is a prioritized status NFID when the priority level indicates the traffic flow is prioritized, and
wherein the NFID is a non-prioritized status NFID when the priority level indicates the traffic flow is not prioritized; and
store the NFID, the associated priority level, and the APPID as an APPID-NFID association in an APPID database.

5. The wireless communication device of claim 4, wherein the processing system is further configured to cause the wireless communication device to:
select the priority level using statically assigned network traffic handling parameters in the network transmission information.

6. The wireless communication device of claim 4, wherein the processing system is further configured to cause the wireless communication device to:
select the priority level using a machine learning (ML) model to identify the traffic flow as a prioritized traffic flow or not prioritized traffic flow.

7. The wireless communication device of claim 1, wherein the traffic flow is a repeated traffic flow, and wherein the processing system is further configured to cause the wireless communication device to:
assign, using APPID-NFID associations stored in an APPID database, the traffic flow to the prioritized network queue when the APPID assigned to the traffic flow is also associated with at least one prioritized status NFID.

8. The wireless communication device of claim 1, wherein the processing system is further configured to cause the wireless communication device to:
receive the traffic flow from an application device via a network connection.

9. The wireless communication device of claim 8, wherein the processing system is further configured to cause the wireless communication device to:
provide the APPID to the application device; and
receive subsequent traffic flow connections, wherein the APPID is pre-associated with the subsequent traffic flow connections received from the application device.

10. The wireless communication device of claim 1, wherein the processing system is further configured to cause the wireless communication device to:
receive the traffic flow from a local instance of the application.

11. A method for wireless communication by a wireless communication device, comprising:
receiving a traffic flow of a plurality of traffic flows for an application,
wherein the traffic flow is associated with a network flow identification (NFID), and
wherein each traffic flow of the plurality of traffic flows is associated with an application identification (APPID) associating the traffic flow to the application; and
providing the traffic flow via a prioritized network queue, wherein at least one traffic flow associated with the APPID is associated with a prioritized status NFID.

12. The method of claim 11, wherein receiving the traffic flow further comprises:
generating the APPID when the traffic flow is a first traffic flow received from the application; and
assigning the APPID to the traffic flow and each of the plurality of traffic flows subsequently received from the application.

13. The method of claim 11, wherein receiving the traffic flow further comprises:
associating the traffic flow to the application when the traffic flow comprises one of:
a repeated traffic flow, or
a subsequent new traffic flow received from the application; and
assigning the APPID to the traffic flow.

14. The method of claim 11, wherein the traffic flow is a new traffic flow received from the application, and wherein the method further comprises:
selecting a priority level using network transmission information in the traffic flow;
extracting the NFID for the traffic flow from the network transmission information;
associating the priority level with the NFID,
wherein the NFID is a prioritized status NFID when the priority level indicates the traffic flow is prioritized, and
wherein the NFID is a non-prioritized status NFID when the priority level indicates the traffic flow is not prioritized; and
storing the NFID, the associated priority level, and the APPID as an APPID-NFID association in an APPID database.

15. The method of claim 14, wherein selecting the priority level from the network transmission information further comprises one or more of:
selecting the priority level using statically assigned network traffic handling parameters in the network transmission information; and
selecting the priority level using a machine learning (ML) model to identify the traffic flow as a prioritized traffic flow or not prioritized traffic flow.

16. The method of claim 11, wherein the traffic flow is a repeated traffic flow, and wherein the method further comprises:
assigning, using APPID-NFID associations stored in an APPID database, the traffic flow to the prioritized network queue when the APPID assigned to the traffic flow is also associated with at least one prioritized status NFID.

17. The method of claim 11, wherein receiving the traffic flow further comprises:
receiving the traffic flow from an application device via a network connection.

18. The method of claim 17, further comprising:
providing the APPID to the application device; and
receiving subsequent traffic flow connections, wherein the APPID is pre-associated with the subsequent traffic flow connections received from the application device.

19. The method of claim 11, wherein receiving the traffic flow further comprises:
receiving the traffic flow from a local instance of the application.

20. An application client device, comprising:
a processing system that includes one or more processors and one or more memories coupled with the one or more processors, the processing system configured to cause the application client device to:
provide a traffic flow of a plurality of traffic flows for an application to a network device, wherein the traffic flow is associated with a network flow identification (NFID),
receive an application identification (APPID) for the traffic flow from the network device, wherein the APPID associates the traffic flow to the application; and
provide the plurality of traffic flows for the application with the APPID to the network device.
